(19) United States
(12) Patent Application Publication
(10) Pub. No.: US 2023/0202892 A1
(43) Pub. Date: Jun. 29, 2023

(54) METHODS FOR INCREASING BIOSOLIDS CAKE DRYNESS THROUGH A FORCED VENTILATION AERATED STATIC PILE BIOLOGICAL DRYING PROCESS

(71) Applicant: JACOBS ENGINEERING GROUP, INC., Dallas, TX (US)

(72) Inventor: Todd O. Williams, Sunset Beach, NC (US)

(21) Appl. No.: 18/145,759

(22) Filed: Dec. 22, 2022

Related U.S. Application Data
(60) Provisional application No. 63/294,439, filed on Dec. 29, 2021.

(51) Int. Cl. C02F 3/30; C02F 3/00; C02F 3/12; C02F 11/04; C02F 3/20; C02F 3/34

(52) U.S. Cl. CPC C02F 3/30; C02F 3/006; C02F 3/1284; C02F 11/04; C02F 3/208; C02F 3/341; C02F 2209/02; C02F 2203/006

(57) ABSTRACT

An example method for drying wastewater solids can include blending an anaerobically digested and de-watered biosolid cake with a previously biodried biosolid to form a mixed biomaterial pile and shaping the mixed biomaterial pile to form a static pile. The method also includes aerating the static pile by forced air ventilation throughout the mixed biomaterial pile to form a biodried material and dividing the biodried material into a recycle biosolid and a dried biomaterial product that is then suitable for disposal or use in agriculture or horticulture applications.

### CROSS REFERENCE TO RELATED APPLICATION

This application claims the benefit of priority to U.S. Application No. 63/294,439, filed Dec. 29, 2021 entitled METHODS FOR INCREASING BIOSOLIDS CAKE DRYNESS THROUGH A FORCED VENTILATION AERATED STATIC PILE BIOLOGICAL DRYING PROCESS, which is hereby incorporated by reference.

### FIELD

The application relates to processes tor increasing the dryness of biosolids cake.

### BACKGROUND

Municipal wastewater treatment plants produce solids that require utilization or disposal. One common stabilization treatment method involves anaerobically or aerobically digesting wastewater solids or sludge to produce biosolids. De-watering of the subsequent biosolids using, for example, belt filter presses, centrifuges or similar, is commonly practiced for ease of subsequent handling. Recent advancements in digestion processes include the application of a hydrolysis step prior to anaerobic digestion such as thermal hydrolysis, chemical thermal hydrolysis, and pasteurization or similar.

The main objectives of the addition of a hydrolysis step to enhance digestion may be to lower the viscosity of digester feed solids, which allows for significantly higher solids loading to existing or new digesters and thereby reducing the needed digester volume; increase volatile solids destruction thereby increasing the amount of biogas produced during digestion and reducing the overall biosolids mass prior to de watering: improve the biosolids de-waterability to further reduce the overall volume and w eight of the resultant biosolids cake; and improve the dewatered biosolids cake quality. However, even with the application of these advanced hydrolysis processes, the dewatered cake produced may still contain a significant amount of water mass, which can render the material suitable only for agricultural land application.

Municipal wastewater utilities generally pay significant costs to transport and land apply these biosolids on agriculture sites based on the weight of the material being hauled. In order to reduce the amount of biosolids weight that must be transported to agriculture, the application of thermal drying, solar drying, windrow air drying or curing, chemical addition, or composting with the addition of bulking agents (such as wood chips or ground brush) have been practiced by some biosolids producers. In many cases, these options allow biosolids producers to utilize the resultant biosolids in horticulture due to the change in biosolids characteristics (dryness) and achieving Class A status, but at a significantly greater overall processing cost.

### SUMMARY

Embodiments disclosed herein include a system for biodrying wastewater solids. In some embodiments, the system may include a first biological component including de-watered anaerobically digested cake solids and a second biological component including biodried solids. The system may further include a mixing station and an aeration system. In some embodiments, the first biological component and the second biological component are combined to form a homogenous mixed biomaterial pile in the mixing station and the mixed biomaterial pile is force ventilated to form a biodried material in the aeration system.

In some embodiments, the first biological component may include cake solids processed by thermal hydrolysis and anaerobically digestion at mesophilic or thermophilic temperatures. The first biological component may include about 25% to about 35% solid material. In some embodiments, the first biological component may include a de-watered anaerobically digested sludge processed with a micro-hydrolysis process including hyper-thermophilic bacteria. The second biological component may include at least a portion of the biodried material produced in the aeration system.

In some embodiments, the mixing station may include at least one of a windrow turner, a rototiller, a pug mill mixer, a mix box, or front end loader or similar equipment to provide mixing. In some embodiments, the homogenous mixed biomaterial pile may initially include between about 38% to about 45% solid material. The homogenous mixed biomaterial pile may include a pile between about 1.5 m and about 4 m in height, between about 2 m and about 10 m in width, and between about 4 m and about 35 m in length. In some embodiments, the homogenous mixed biomaterial pile may include a mass bed having at least two piles situated adjacent to each other.

In some embodiments, the aeration system can include a ventilation conduit in fluid communication with a pressurized air source and a plurality of delivery conduits disposed within the homogenous mixed biomaterial pile, the delivery conduits extending from the ventilation conduit and configured to deliver air to the pile to promote an aerobic biological process and control internal pile temperatures. In some embodiments the aeration system can operate in a vacuum mode drawing air down through the biomaterial pile and exhausting that air through an odor control system such as a biofilter. In some embodiments, the aeration system may include a membrane cover over the mixed biomaterial pile. The system for biodrying wastewater solids may further include a temperature feedback control system coupled to the aeration system, the temperature feedback control system configured to control pile temperatures and drying rate.

A method for drying wastewater solids may include blending an anaerobically digested and de-watered biosolid cake with a previously biodried biosolid to form a mixed biomaterial, shaping the mixed biomaterial to form a pile, and aerating the pile by forced air ventilation throughout the mixed biomaterial to form a biodried material. The method may further include dividing the biodried material into a recycle biosolid and a dried biomaterial product. The recycle biosolid may be recycled to form at least a portion of the previously biodried biosolid and the dried biomaterial product may be divided into portions.

In some embodiments, the method for drying wastewater solids may further include performing a thermal hydrolysis process to form the anaerobically digested and de-watered biosolid cake, wherein the thermal hydrolysis process includes heating a wastewater sludge to between about 140° C. to about 185° C. In some embodiments, aerating the pile may include a continuous forced ventilation of the pile. In other embodiments, aerating the pile may include an intermittent forced ventilation of the pile. Aerating the pile may include at least one of a positive aeration or a negative aeration of the pile. The method may include aerating the pile and achieving thermophilic temperatures within the pile for at least 72 hours.

In some embodiments, blending the anaerobically digested and de-watered biosolid cake with a previously biodried biosolid forming the mixed biomaterial may include about a 1:1 ratio by volume of the pre-dried biosolids to the anaerobically digested and de-watered biosolid cake. This ratio may be as high as about 1.5:1 or as low as 0.5:1 depending on the solids content of the de-watered biosolid cake. Shaping the mixed biomaterial to form a pile may include stacking the mixed biomaterial pile into a static pile and in one example, the pile is between about 1.5 m and about 4 m in height, between about 2 m and about 10 m in width, and between about 4 m and about 35 m in length. In some embodiments, shaping the mixed biomaterial to form a pile may include placing the mixed biomaterial into an agitated bay composting system.

A process for biologically drying anaerobically digested municipal waste may include forming a pile of a mixture of a mesophilically or thermophilically anaerobically digested cake solid and a biodried cake solid. In some embodiments, the pile may include a height between about 1.5 meters and about 4 meters and the initial mixture includes between about 38 percent and about 45 percent solids. The process may also include aerating the pile by forced air ventilation to form an aerated pile of biodried cake material. The aerated pile may include an area between about 2 meters to about 10 meters wide and between about 4 and about 35 meters long. In some embodiments, live aerated pile may include at least one of a free-standing pile, a pile contained by walls, or a mass bed.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic view of a system for biodrying wastewater solids, according to an embodiment.

FIG. 2A is an isometric view of the system shown in FIG. 1, according to an embodiment.

FIG. 2B is an isometric schematic view of an aeration system, according to an embodiment.

FIG. 3 is a cross-sectional schematic of an aeration system, according to an embodiment.

FIG. 4A is an isometric schematic view of an aeration system during positive aeration, according to some embodiments.

FIG. 4B is an isometric schematic view of an aeration system during negative aeration, according to some embodiments.

FIG. 5 a flow diagram of a method for drying wastewater solids, according to some embodiments.

### DETAILED DESCRIPTION

Embodiments disclosed herein are related to assemblies, systems, and methods of using a system for biodrying wastewater solids. The assemblies, systems, and methods of using a system for biodrying wastewater solids ore configured and designed to increase solids content of de-watered biosolids produced from thermally hydrolyzed anaerobically digested municipal sludge or similar waste material through a biological drying process without the addition of external chemicals.

The systems for biodrying wastewater solids disclosed herein may include a de-watered anaerobically digested cake solids. Prior to utilization or disposal, the wastewater solids from a municipal wastewater treatment plant usually require treatment to meet various environmental regulations to achieve status as biosolids, which can be land applied in various forms. For example, the U.S. Environmental Protection Agency requires stabilization of wastewater solids or sludge to be classified as Class B or Class A biosolids, which are then suitable to be utilized in land application in agriculture or horticulture practices.

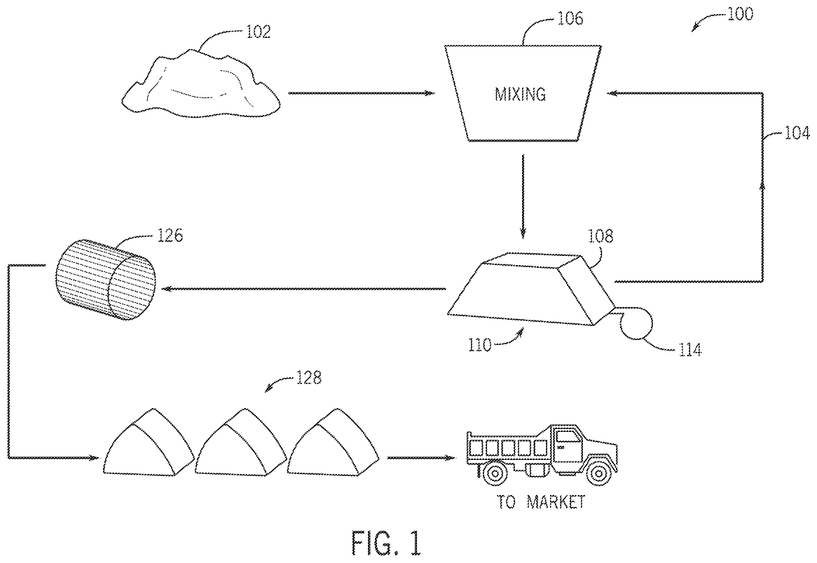

FIG. 1 is a schematic view of a system 100 for biodrying wastewater solids, according to some embodiments. The system 100 may include a first biological component 102 and a second biological component 104. The first biological component 102 may include de-watered anaerobically digested cake solids, in some embodiments. The de-watered anaerobically digested cake solids may be produced from thermally hydrolyzed and anaerobically digested municipal sludge. The first biological component 102 may include cake solids processed by thermal hydrolysis and anaerobically digested at mesophilic or thermophilic temperatures. In some embodiments, the first biological component may include about 25 percent to about 35 percent solid material and may be classified as sludge or biosolids. Sludge may be defined as a semi-solid slurry that can be produced from a range of industrial processes, from water treatment, wastewater treatment or on-site sanitation systems and/or semi-solids such as organic waste (e.g. excrement) that settles down during wastewater treatment. Thermal hydrolysis may include a process that exposes sewage sludge or other types of wet organic waste (e.g. biosolids) to a high temperature and pressure to improve the digestibility of the biosolids, usually before anaerobic digestion. In some embodiments, the biosolids may be heated to between about 140° C. and about 185° C. and kept at the high temperature for greater than about 20 minutes. The thermal hydrolysis process may typically be set at 20 to 30 minutes for each batch or operated in a continuous pass-through mode, to ensure pathogen kill. The biosolids may then be transferred for anaerobic digestion. One benefit provided by thermal hydrolysis may be enhancement of the digestion process for improved conversion of volatile solids and improved de-waterability of the biosolids. In some embodiments, the sludge may then be cooled to the typical temperature for anaerobic digestion (e.g. in heat exchangers). Then it may be led to anaerobic digesters.

Anaerobic digestion may be defined as a process through which bacteria break down organic matter (e.g. animal manure, wastewater biosolids, and food wastes) in the absence of oxygen. In some embodiments, the anaerobic digestion of the first biological component 102 may occur at either mesophilic temperatures, thermophilic temperatures, or a combination of mesophilic and thermophilic temperatures. Mesophilic temperatures may be defined as between about 20° C. and about 40° C. and thermophilic temperatures may be defined as between about 40° C. and about 65° C. Anaerobic digestion can be performed as a batch process or a continuous process. In a batch system, biomass is added to the reactor at the start of the process. The reactor is then sealed for the duration of the process. In continuous digestion processes, organic matter is constantly added or may be added in stages to the reactor (e.g. continuous plug flow or complete mix). For continuous processes, the end products are constantly or periodically removed, resulting in constant production of the first biological component 102. In some embodiments, single or multiple digesters in sequence may be used. Examples of this form of anaerobic digestion include continuous stirred-tank (complete mix) reactors, upflow anaerobic sludge blankets, expanded granular sludge beds, and internal circulation reactors.

In some embodiments, the first biological component 102 may be produced by microbial hydrolysis. Hydrolysis generally refers to the breakdown of polymeric substances into their monomeric building blocks. In the case of microbial hydrolysis, the breakdown is catalyzed by extracellular enzymes produced by microorganisms. The hydrolysis stage is usually dominated by bacteria. In some embodiments, the bacteria may include hyper-thermophilic bacteria such as Caldicellulosiruptor bescii or similar.

In some embodiments, the second biological component 104 may include at least a portion of Ok biodried material produced in an aeration system described in more detail below. The second biological component 104 may include biodried solids. The biodried solids may be recycled from the output of the system 100 for biodrying wastewater solids described herein or may be previously dried and produced from other suitable methods. In some embodiments, the second biological component 104 may be recycled directly from a portion of the system 100 or may be dried to be stored and used in a future trine. In some embodiments, the second biological component 104 may be mixed with the first biological component 102 at a mixing station 106.

In some embodiments, the mixing station 106 may include at least one of a windrow turner, a rototiller, a pug mill mixer, a mix box, a front end loader, or similar mixing system. The first biological component 102 and the second biological component 104 may be combined to form a homogenous mixed biomaterial pile 108. In some embodiments, the homogenous mixed biomaterial pile 108 may initially include between about 38% to about 45% solid material. In some embodiments, the ratio of the first biological component 102 and the second biological component 104 may be between about 1:0.5 to 1:1.5 or between about 1:0.5 to 1:2.0 on a volume-to-volume basis. In other words, the volume of second biological component 104 of previously biodried solids may be no more than about 150% or no more than about 200% of the first biological component 102. Blending or mixing these two components (104 with 102) to a high enough solids content with previously biodried material creates a mixture with sufficient porosity to aerate the mixed biomaterial pile 108 when placed over or in aeration system 110.

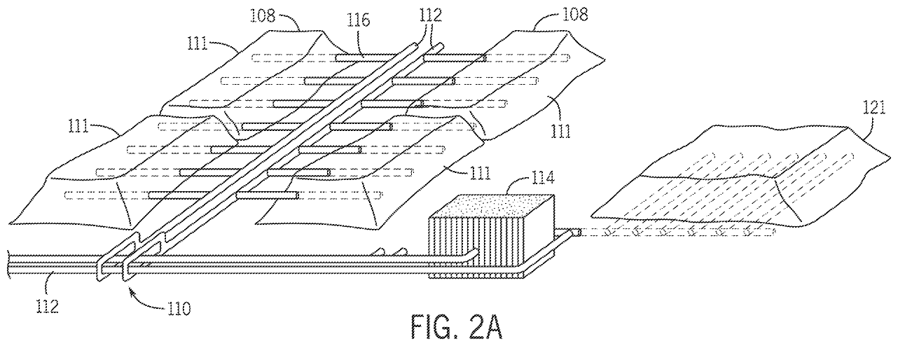

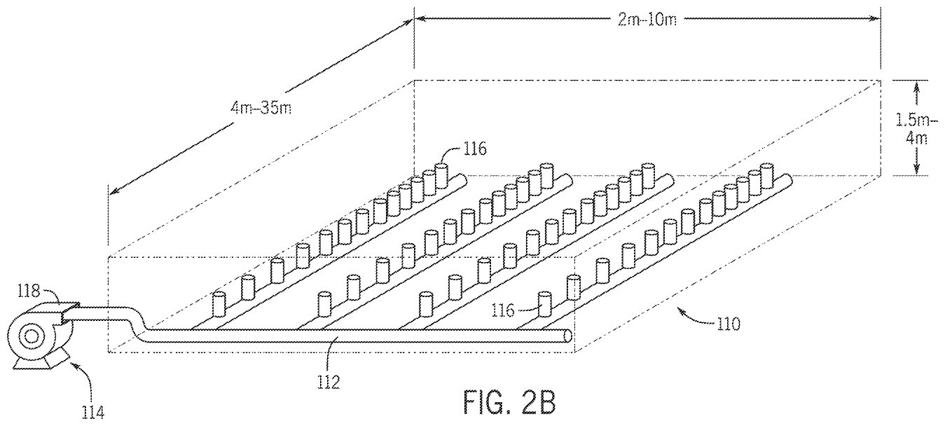

FIG. 2A is an isometric view of the system 100 for biodrying wastewater solids, according to an embodiment. As shown in FIG. 2A, the mixed biomaterial pile 108 may be built and/or stacked over aeration system 110 at the mixing station 106. In some embodiments, the mixed biomaterial pile 108 may be stacked at either the mixing station 106 or in an aerator system 110. In some embodiments, the mixed biomaterial pile 108 may include a series of piles. In some embodiments, the mixed biomaterial pile 108 may include a mass bed 111. The mass bed 111 may be at least two individual piles situated adjacent to each other. In some embodiments, the mixed biomaterial pile 108 may include at least one of an individual pile, an extended pile, a bin, a bunker, a bay, or an agitated bay.

FIG. 2A and FIG. 2B illustrate the mixed biomaterial pile 108 with the aeration system 110 disposed therein, in other words, the mixed biomaterial pile 108 is stacked on the aeration system 110. FIG. 2B is an isometric schematic view of the aeration system 110, according to an embodiment. As shown in FIG. 2B, the homogenous mixed biomaterial pile 108 may include a pile between about 1.5 m and about 4 m in height. In some embodiments, the pile 108 may include a width between about 2 m and about 10 m and be between about 4 m and about 35 m in length. In some embodiments, the aeration system 110 is configured to force ventilate the mixed biomaterial pile 108 to form a biodried material.

In some embodiments, the aeration system 110 may include a ventilation conduit 112 in fluid communication with a pressurized air source 114. The aeration system may further include a plurality of delivery conduits 116 disposed within the homogenous mixed biomaterial pile 108. The delivery conduits 116 extend from the ventilation conduit 112 and configured to deliver air to the pile to promote an aerobic biological process and control internal pile temperatures. The aeration system 110 provides air and oxygen to maintain an aerobic process, to cool the process by removing naturally generated heat, and to remove moisture from the pile.

The ventilation conduit 112 may be manufactured from PVC, HDPE, or any other material suitable for forced air transport. Other embodiments may include flexible ductwork, metal ducts, concrete ducts, plastic or polymerized concrete ducts, rigid piping, etc. The ventilation conduit 112 couples the delivery conduits 116 to the pressurized air source 114. The pressurized air source 114 may be configured either to provide air under positive pressure or negative pressure.

The pressurized air source 114 may include at least one blower 118. The blower 118 can include an external blower 118 configured to blow air through the mixed biomaterial pile 108 to achieve anchor maintain a thermophilic temperature within the mixed biomaterial pile 108 and promote the aerobic biological processes. In some embodiments, the blower 118 may include a series of blowers. Centrifugal blowers in single unit and multiple independent unit configurations may provide a flow or movement of air sufficient to maintain the required temperatures and oxygen to enable or promote an aerobic exothermic biological process, to cool the process by removing heat, and to remove moisture from the mixed biomaterial pile 108. In some embodiments, the pressurized air source 114 may be operated either intermittently or continuously for approximately three to twenty one days.

The delivery conduits 116 extend from the ventilation conduit 112 and are configured to aerate the mixed biomaterial pile 108. No additional sealing of the mixed biomaterial pile 108 by inoculation with external bacteria, fungi, or other microbes is included. In some embodiments, the delivery conduits 116 may include an aeration plenum disposed beneath the mixed biomaterial pile 108 and may include piping, ductwork, nozzles, grates, or other suitable air conveyance systems to supply air to the mixed biomaterial pile 108. In some embodiments, the delivery conduits 116 may be configured to deliver about the same flow rate through each delivery conduit so as to provide a relatively even distribution of air to all portions of the mixed biomaterial pile 108. In some embodiments, the delivery conduits 116 may extend into at least a portion of the mixed biomaterial pile 108.

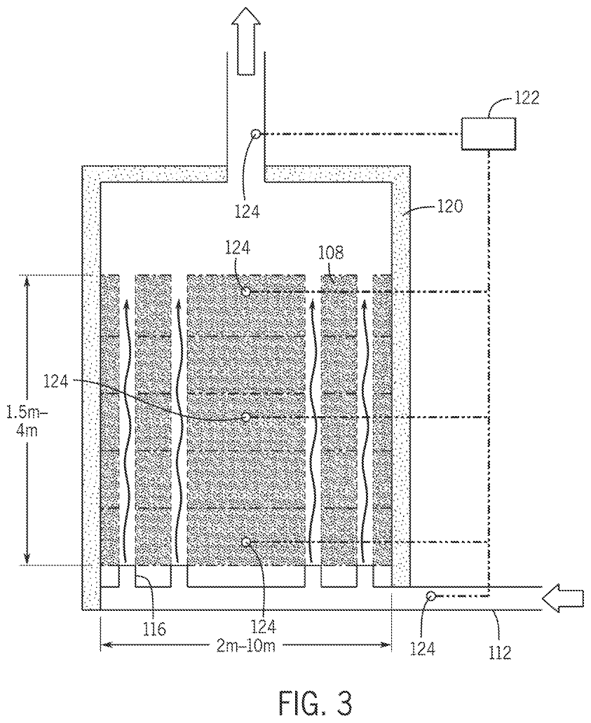

Referring now to FIG. 3, in some embodiments, the aeration system 110 includes a membrane cover 120 over the mixed biomaterial pile 108. The cover 120 may be drawn over the mixed biomaterial pile 108 to protect the mixed biomaterial pile 108 against weather impacts and to contain odors or other fugitive emissions. The cover 120 may be permeable for air and moisture, but impermeable to odor, dust, germs, and/or bacterium. The membrane cover 120 may protect against wind and help control temperatures. In some embodiments, the membrane cover 120 may include expanded polytetrafluoroethylene or other suitable breathable materials.

In some embodiments, the system 100 for biodrying wastewater solids may include a temperature feedback control system 122 coupled to the aeration system 110. FIG. 3 is a cross-sectional schematic of the aeration system 110, according to an embodiment. The temperature feedback control system 122 may be configured to control pile temperatures and drying rate. Naturally occurring microbes within the mixed biomaterial pile 108 respire and give off heat in the aerobic process which increases the temperature of the mixed biomaterial pile 108 to about thermophilic temperatures. The temperature feedback control system 122 may include at least one temperature sensor 124. The aeration rate provided to the aeration system 110 may be adjusted and/or controlled based on measurements from the temperature sensor 124. In some embodiments, the temperature feedback control system 122 may be operationally coupled to the pressurized air source 114 to control the blower(s) 118. The blower 118 may include a variable frequency drive control, modulating aeration control valves, or other suitable system coupled to the temperature feedback control system 122 to automatically control the aeration rate provided by the blower(s) 118 to maintain temperature of the mixed biomaterial pile 108 between about 30° C. and about 65° C.

In some embodiments, the temperature feedback control system 122 may include temperature sensors 124 located within at least one of the ventilation conduits 112, at least one delivery conduit 116, within the bottom, middle, or top of the mixed biomaterial pile 108, and/or a ventilation outlet In some embodiments, the temperature sensors 124 may include thermistors, RTDs, or linear devices. With these types of sensors, stabilities of 0.01° C. to 0.001° C. are commonly achievable. Less precise sensors—thermocouples—can also be used for stabilities of about 1° C. Power must be provided to the control electronics and current source. This can take the form of a DC power supply or an AC input connector.

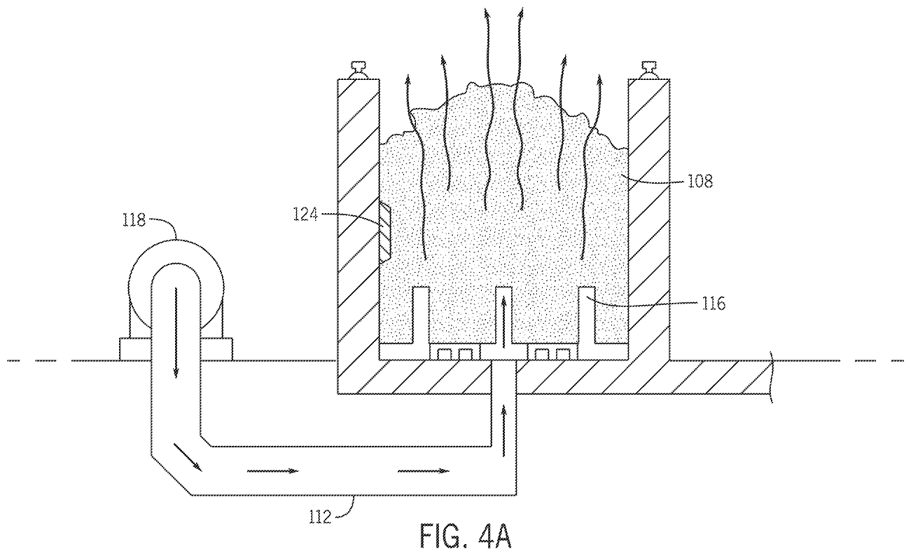

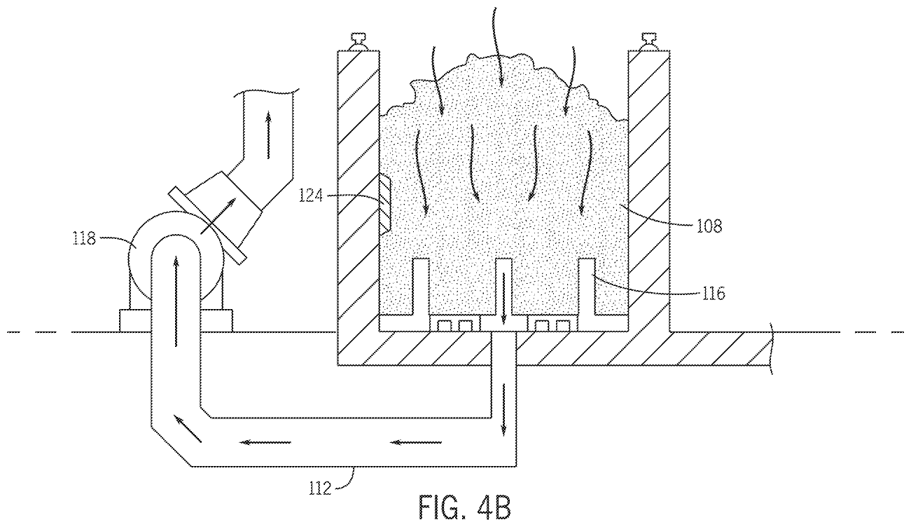

Referring to FIGS. 4A-4B, the aeration system 110 can be configured to either blow air into or draw air out of the mixed biomaterial pile 108. Depending on the configuration and the structure of the aeration system 110 and the mixed biomaterial pile 108, the aeration system 110 must be designed to move air through the pile in the most effective and efficient way. FIG. 4A is an isometric schematic view of an aeration system during positive aeration, according to some embodiments. Positive pressure or push aeration systems may include the pressurized air source 114 blowing air into the mixed biomaterial pile 108 at the bottom through the delivery conduits 116. The air may then be exhausted with exhaust fans from the top of the mixed biomaterial pile 108, with passive venting above the pile 108 or with a combination of power exhaust fans and passive vents or space above the pile. Air will heat a few degrees from the respiration of the biomaterial as the air goes through the pile 108, compared to negative pressure (see below) systems. The warmer air rises and the positive pressure system takes advantage of that natural warm air movement.

FIG. 4B is an isometric schematic view of an aeration system during negative aeration, according to some embodiments. For the negative pressure system, aeration conduits may be located at the bottom of the mixed biomaterial pile 108 and blowers 118 configured to pull air down through the pile 108. Adequate air intake is essential for a negative pressure system to work correctly. An advantage to a negative pressure system is that the exhaust air can be easily monitored for temperature within the ventilation conduit 112 and/or deliver conduits 116, which makes controlling the temperature with temperature feedback control system 122 relatively easier. Another advantage of a negative pressure system is that the exhaust air can be conveyed to and treated through odor control device(s) such as a biofilter (such as biofilter 121 shown in FIG. 2A), carbon filter or chemical scrubber if needed.

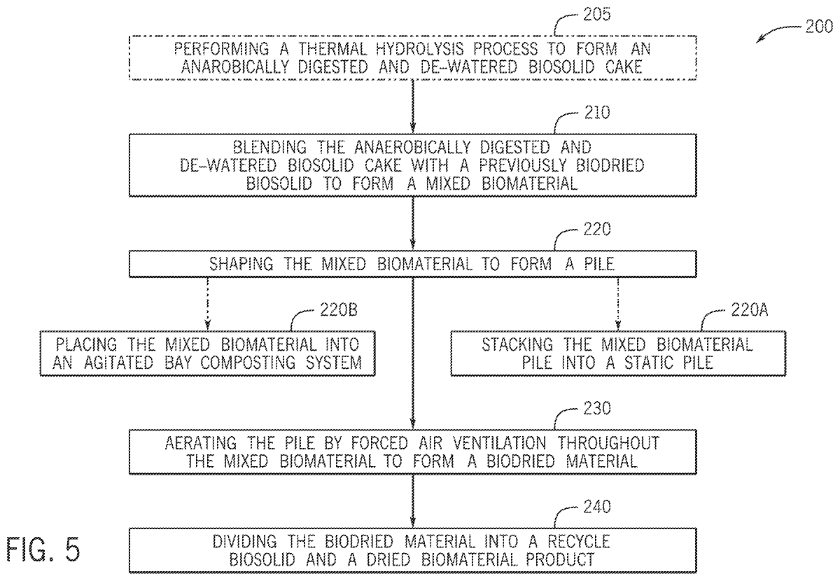

FIG. 5 is a flow diagram of a method or process 200 for biologically drying anaerobically digested municipal waste and/or wastewater solids, according to some embodiments, lire method 200 of drying wastewater solids may utilize use any of the assemblies and/or systems for biodrying wastewater solids disclosed herein. In some embodiments, the method 200 may include an act 205. Act 205 may include performing a thermal hydrolysis process to form the anaerobically digested and de-watered biosolid cake. In some embodiments, act 205 may include heating a wastewater sludge to between about 140° C. to about 185° C. for at least about 20 minutes. One benefit provided by thermal hydrolysis process may include a more efficient anaerobic digestion process for improved conversion of volatile solids and improved de-waterability of the biosolids.

The method 200 may include act 210, which includes blending an anaerobically digested and de-watered biosolid cake with biodried biosolid to form a mixed biomaterial. Blending the anaerobically digested and de-watered biosolid cake with biodried biosolids may include mixing a portion of previously biodried biosolids with dewatered anaerobically digested cake from an anaerobic digestion system operating at mesophilic temperatures, thermophilic temperatures, or digestion coupled with a hydrolysis process such as microbial-hydrolysis with a hyper-thermophilic bacteria. In some embodiments the hyper-thermophilic bacteria may include Caldicellulosiruptor bescii or similar. In some embodiments, act 210 may include blending the anaerobically digested and de-watered biosolid cake with a biodried biosolid to about a 1:1 ratio by volume of the previously biodried biosolids to the anaerobically digested and de-watered biosolid cake. Blending the anaerobically digested and de-watered biosolid cake with a biodried biosolid may be performed via front end loaders, window turners, rototillers, pug mill mixers, mix boxes, or another suitable process or assembly.

Act 210 may be followed by act 220, which includes shaping the mixed biomaterial to form a pile. In some embodiments, act 220 may include forming a pile of a mixture of a mesophilically or thermophilically anaerobically digested cake solid and a biodried cake solid. The pile may include an initial mixture of between about 38 percent and about 45 percent solids. In some embodiments, shaping the mixed biomaterial to form a pile includes an act 220A of stacking the mixed biomaterial pile into a static pile between about 1.5 m and about 4 m in height, between about 2 m and about 10 m in width, and between about 4 m and about 35 m in length. The static pile may include the biomaterial stacked in individual piles, extended piles, bins, bunkers, bays and/or agitated bays having an aeration system disposed therein.

In other embodiments, shaping the mixed biomaterial to form a pile may include an act 220B of placing the mixed biomaterial into an agitated bay composting system. The agitated bay composting technology may incorporate composting in long parallel channels with walls separating the channels, and an automated compost turner traveling on the lop of the walls. In some embodiments, the turners can move from one channel to the next on a transfer dolly at the completion of each cycle. Forced aeration may be included in the channels, and the aeration cycle may be controlled either on a timer, a temperature feedback basis, or both. Temperature of the composting material in the channels may be monitored by temperature sensors embedded at locations in the walls. The regular agitation may provide improved porosity of the pile and an operational and process control flexibility. Because of the relatively small mass of compost within each channel or aeration zone of the channel, automated aeration control may provide a potentially relatively large change in aeration rate and temperature change to promote or reduce drying and oxygenation of the mixed biomaterial.

The method 200 may include act 230 including aerating the pile by forced air ventilation throughout the mixed biomaterial to form a biodried material. In some embodiments, aerating the pile in act 230 may include a continuous forced ventilation of the pile. In other embodiments, aerating the pile in act 230 may include an intermittent forced ventilation of the pile. Aerating the pile may include at least one of a positive aeration or a negative aeration of the pile described above in reference to FIGS. 4A-4B. In some embodiments, in act 230, the pile may be aerated for at least 72 hours. In some embodiments, the pile may be aerated either intermittently or continuously for between about 3 days to about 21 days.

Act 230 may include an aeration rate configured to maintain average temperatures of the pile between about 30° C. and about 65° C. for the duration of the process. In other words, method 200 is configured to occur at a temperature between about 30° C. and about 65° C. The process may be configured to reduce the moisture concentration of the mixed biomaterial to between about 30 percent and about 45 percent water. In other words, the biodried material formed from aerating the pile by forced air ventilation throughout the mixed biomaterial includes between about 55 percent and about 70 percent solids, thereby substantially decreases the mass of the biodried material compared to the dewatered biosolids cake and the mixed biomaterial. In some embodiments, the biodried material may resemble a friable granular soil alter act 230.

The method 200 may further include act 240 of dividing the biodried material into a recycle biosolid and a dried biomaterial product. In some embodiments, the recycle biosolids may be recycled to form at least a portion of the previously biodried biosolids discussed above in act 210. The recycle biosolids may be recycled directly, in some embodiments, or they may be stored and/or processed for biter use at the same or a different facility.

Acts 210-240 of the method 200 are for illustrative purposes. For example, the acts 220 and 230 of the method 200 may be performed in different orders, split into multiple acts, modified, supplemented, or combined. In an example, one or more of the acts 210 or 220 of the method 200 may be omitted from the method 200. Any of the acts 210 to 240 may include using any of the assemblies or systems disclosed herein.

Referring back to FIG. 1, the dried biomaterial product may be further processed, in some embodiments, the dried biomaterial product may be sized by a mechanical processor 126. The mechanical processor 126 may include a machine that performs at least one of screening, grinding, pulverizing, or other suitable mechanical process to shape the dried biomaterial product into a uniform size product. In some embodiments, the product may then be stored in a bulk storage 128 prior to being transported to market.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded comers instead of sharp comers, curved edges instead of straight edges, one or more protrusions extending therefrom, is oblong, is the same as the disclosed shape, etc.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A system for biodrying wastewater solids, comprising:
a first biological component including do-watered anaerobically digested cake solids;
a second biological component including biodried solids;
a mixing station, wherein the first biological component and the second biological component are combined to form a homogenous mixed biomaterial pile; and
an aeration system, wherein the mixed biomaterial pile is force ventilated to form a biodried material.

2. The system of claim 1, wherein the first biological component comprises cake solids processed by thermal hydrolysis and anaerobically digested at mesophilic or thermophilic temperatures.

3. The system of claim 1, wherein the first biological component comprises about 25% to about 35% solid material.

4. The system of claim 1, wherein the first biological component comprises a de-watered anaerobically digested sludge processed with a micro-hydrolysis process including hyper-thermophilic bacteria.

5. The system of claim 1, wherein the second biological component comprises at least a portion of the biodried material produced in the aeration system.

6. The system of claim 1, wherein the mixing station comprises at least one of a windrow turner, a rototiller, a pug mill mixer, a mix box, or front end loader mixing.

7. The system of claim 1, wherein the homogenous mixed biomaterial pile comprises:
an initial mixture between about 38% to about 45% solid material; and/or
a pile between about 1.5 m and about 4 m in height, between about 2 m and about 10 m in width, and between about 4 m and about 35 m in length; and/or
a mass bed having at least two piles situated adjacent to each other.

8. (canceled)

9. (canceled)

10. The system of claim 1, wherein the aeration system comprises:
a ventilation conduit in fluid communication with a pressurized air source; and
a plurality of delivery conduits disposed within the homogenous mixed biomaterial pile, the delivery conduits extending from the ventilation conduit and configured to deliver air to the pile to promote an aerobic biological process and control internal pile temperatures.

11. The system of claim 1, wherein the aeration system comprises a membrane cover over the mixed biomaterial pile.

12. The system of claim 1, further comprising a temperature feedback control system coupled to the aeration system, the temperature feedback control system configured to control pile temperatures and drying rate.

13. A method for drying wastewater solids, comprising:
blending an anaerobically digested and de-watered biosolid cake with a pre-dried biosolid to form a mixed biomaterial;
shaping the mixed biomaterial to form a pile;
aerating the pile by forced air ventilation throughout the mixed biomaterial to form a biodried material; and
dividing the biodried material into a recycle biosolid and a dried biomaterial product, wherein the recycle biosolid is recycled to form at least a port ion of the previously dried biosolid and the dried biomaterial product is divided to various portions.

14. The method of claim 13, further comprising performing a thermal hydrolysis process to form the anaerobically digested and de-watered biosolid cake, wherein the thermal hydrolysis process includes heating a wastewater sludge to between about 140° C. to about 185° C.

15. The method of claim 13, wherein aerating the pile comprises a continuous forced ventilation of the pile, or an intermittent forced ventilation of the pile.

16. (canceled)

17. The method of claim 13, wherein aerating the pile comprises at least one of a positive aeration or a negative aeration of the pile.

18. The method of claim 13, wherein blending an anaerobically digested and de-watered biosolid cake with a previously biodried biosolid to form the mixed biomaterial includes between about a 0.5:1 ratio and about a 2.0:1 ratio by volume of the previously biodried biosolids to the anaerobically digested and de-watered biosolid cake.

19. The method of claim 13, further comprising aerating the pile and maintaining thermophilic temperatures of 40° C. or higher within the pile for at least 72 hours.

20. The method of claim 13, wherein shaping the mixed biomaterial to form a pile comprises stacking the mixed biomaterial pile into a static pile between about 1.5 m and about 4 m in height, between about 2 m and about 10 m in width, and between about 4 m and about 35 m in length.

21. The method of claim 13, wherein shaping the mixed biomaterial to form a pile comprises placing the mixed biomaterial into an agitated bay composting system.

22. A process for biologically drying anaerobically digested municipal waste, comprising:
forming a pile of a mixture of a mesophilically or thermophilically anaerobically digested cake solid and a biodried cake solid, wherein the pile comprises a height between about 1.5 meters and about 4 meters and the initial mixture includes between about 38 percent and about 45 percent solids; and
aerating the pile by forced air ventilation to form an aerated pile of biodried cake material, wherein the aerated pile comprises an area between about 2 meters to about 10 meters wide and between about 4 and about 35 meters long.

23. The process of claim 22, wherein the aerated pile comprises at least one of a free-standing pile, a pile contained by walls, or a mass bed.
